(19) United States
(12) Patent Application Publication
(10) Pub. No.: US 2015/0167596 A1
(43) Pub. Date: Jun. 18, 2015

(54) COOLER FOR EXHAUST GAS RECIRCULATION VALVE

(71) Applicant: Caterpillar Inc., Peoria, IL (US)

(72) Inventors: Catalin M. Tiru, Lafayette, IN (US); Jeremy Byrd, West Lafayette, IN (US); Keith W. Mellencamp, Lafayette, IN (US)

(73) Assignee: Caterpillar Inc., Peoria, IL (US)

(21) Appl. No.: 14/104,491

(22) Filed: Dec. 12, 2013

(51) Int. Cl. F02M 25/07

(52) U.S. Cl. CPC F02M 25/0798

(57) ABSTRACT

An Exhaust Gas Recirculation valve (EGR) for an engine is provided. The EGR valve includes an actuator having a shaft. The EGR valve includes a cooling block. The cooling block has an inlet configured to receive a coolant flow. A top face of the cooling block has a recess. The recess is configured to house at least a portion of the actuator therein. A through hole is provided on the cooling block and is configured to allow the shaft to pass therethrough. The cooling block includes an internal chamber in fluid communication with the inlet. The internal chamber is configured to provide a path for the coolant flow to circulate through the cooling block. An outlet of the cooling block is configured to discharge the coolant flow. A valve body is fluidly coupled to the cooling block. The valve body may include at least one cooling passage.

### TECHNICAL FIELD

The present disclosure relates to an exhaust gas recirculation valve, and more specifically to a cooling system for the exhaust gas recirculation valve.

### BACKGROUND

Exhaust gas recirculation systems (EGR) are commonly used in a variety of engine applications. The EGR technique involves a recirculation of exhaust gas into an intake manifold of an engine. The exhaust gas which is reintroduced into the intake manifold may contain a relatively reduced concentration of oxygen therein, as compared to that of free air. This may allow for a reduction in combustion temperature within a cylinder of the engine. The lowered temperature may in turn decrease a rate of a chemical reaction of the combustion process, thereby causing a decrease in the formation of nitrogen oxides (NOx). Sometimes, the exhaust gas may contain a portion of unburned hydrocarbon (HC), which may get burned when reintroduced into the cylinder. This may result in a reduction in emission of exhaust gas by-products into the atmosphere.

An EGR valve associated with the EGR system controls a flow of the exhaust gas being reintroduced into the intake manifold. An EGR cooler may be coupled to the EGR valve for reducing a temperature of the exhaust gas prior to the reintroduction.

### SUMMARY OF THE DISCLOSURE

In one aspect of the present disclosure, an Exhaust Gas Recirculation valve (EGR) for an engine is provided. The EGR valve includes an actuator having a shaft. The EGR valve also includes a cooling block. The cooling block has an inlet configured to receive a coolant flow. A top face of the cooling block has a recess. The recess is configured to house at least a portion of the actuator therein. A through hole is provided on the cooling block and is configured to allow the shaft to pass therethrough. The cooling block includes an internal chamber in fluid communication with the inlet. The internal chamber is configured to provide a path for the coolant flow to circulate through the cooling block. An outlet of the cooling block is configured to discharge the coolant flow. A valve body is fluidly coupled to the cooling block. The valve body may include at least one cooling passage.

Other features and aspects of this disclosure will be apparent from the following description and the accompanying drawings.

### BRIEF DESCRIPTION OF THE DRAWINGS

FIG. 1 is an perspective view of an exemplary exhaust gas recirculation (EGR) valve;

FIG. 2 is a perspective view of a cooling block for the EGR valve of FIG. 1; and

FIG. 3 is a sectional view of the cooling block of FIG. 2.

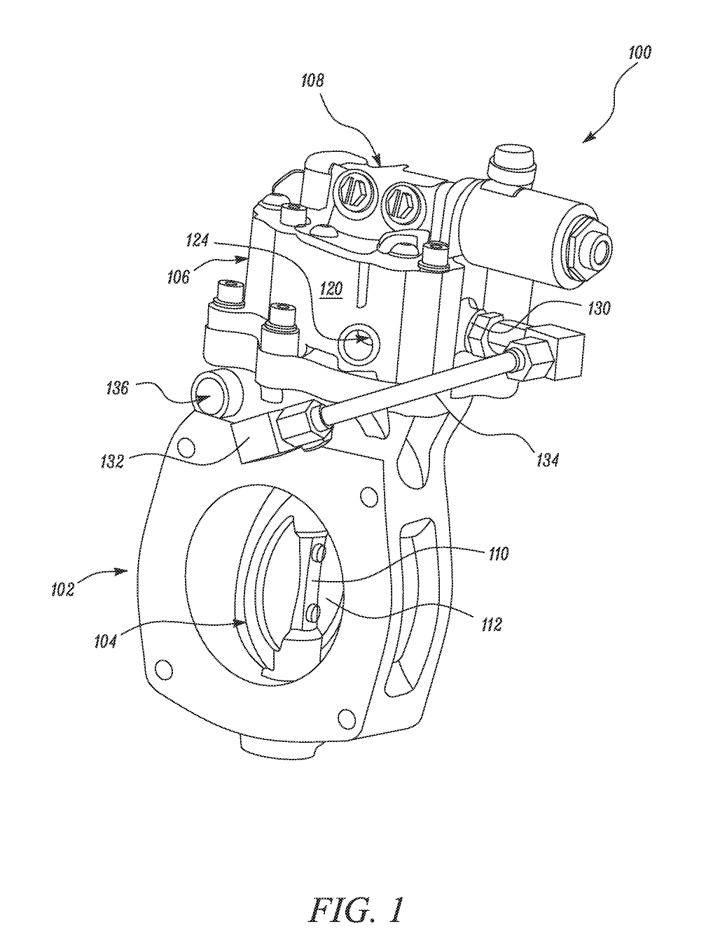

### DETAILED DESCRIPTION

Wherever possible, the same reference numbers will be used throughout the drawings to refer to the same or the like parts. FIG. 1 illustrates a perspective view of an exemplary Exhaust Gas Recirculation (EGR) valve 100, according to one embodiment of the present disclosure. The EGR valve 100 illustrated in the accompanying figures is a butterfly valve. A person of ordinary skill in the art will appreciate that the valve 100 shown in the accompanying drawings is exemplary and does not limit the scope of the present disclosure. The EGR valve 100 may be associated with an exhaust manifold (not shown) of an engine (not shown), such that the EGR valve 100 may control a volume of exhaust gas reintroduced into the intake manifold.

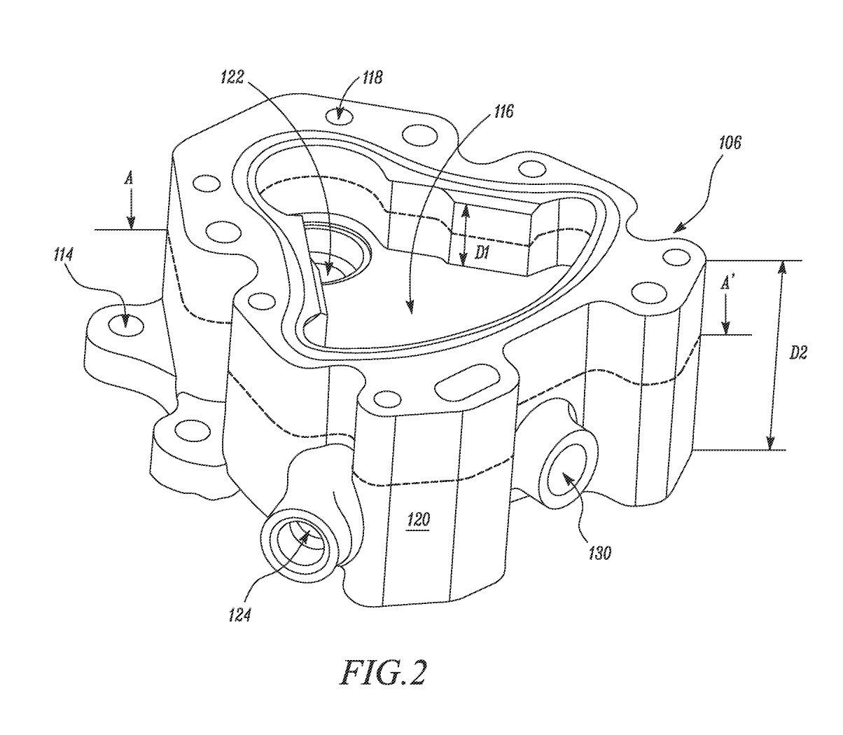

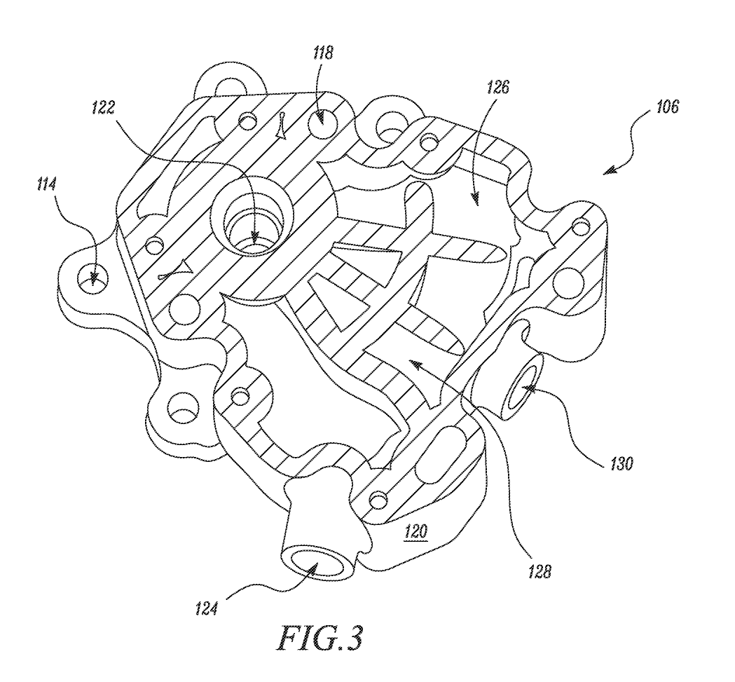

The EGR valve 100 includes a valve body 102 that includes an inner passage for coolant to flow therethrough as will be discussed in more detail below. The valve 100 may include a duct 104 configured to allow a passage of exhaust gas therethrough. A cooling block 106 is disposed atop the valve body 102. The cooling block 106 will be described in detail in connection with FIGS. 2 and 3. An actuator 108 configured to control a movement of the EGR valve 100 is coupled to the cooling block 106. The actuator 108 may include, but is not limited to, a mechanical linkage actuator, a hydraulic actuator, and an electronic actuator. The actuator 108 may include a shaft 110 extending therethrough. A valve element 112 may be attached to the shaft 110 in relation to the duct 104. The actuator 108 may include an actuating member (not shown) capable of rotation about the shaft 110. Based on the movement of the actuator 108, the shaft 110 may cause the valve element 112 to rotate within a range from 0 degrees to about 73 degrees in order to open or close the duct 104 for controlling the passage of the exhaust gas therethrough.

FIG. 2 illustrates a perspective of the cooling block 106. The cooling block 106 may include a plurality of eyelet 114 for mounting the cooling block 106 atop the valve body 102. In the accompanying figures, two pairs of eyelets 114 extend from a base of the cooling block 106, and the eyelets 114 are provided on both sides of the cooling block 106. The cooling block 106 may be attached to the valve body 102 using mechanical fasteners as shown in FIG. 1. Alternatively, the cooling block 106 may be coupled to the valve body 102 using any other known method.

A top face of the cooling block 106 includes a recess 116. The recess 116 is shaped in a manner so as to at least partially house the actuator 108 therein. The actuator 108 may be attached to the top face of the cooling block 106 using any known method. For example, mechanical fasteners may be provided through a hole 118 provided on the top face. In the accompanying figures, the holes 118 are provided along a periphery of an outer wall 120 of the cooling block 106 for the attachment. Also, a depth D1 of the recess 116 is lesser than an overall depth D2 of the cooling block 106, such that a portion of the cooling block 106 may reside between the actuator 108 and the valve body 102.

The recess 116 may further enclose a lubricating fluid, such as oil, therein. Also, the shape of the recess 116 may have an arcuate shape, in order to accommodate the movement of the actuator 108. A through hole 122 provided in the cooling block 106 may allow the shaft 110 to pass therethrough.

The cooling block 106 may include an inlet 124. The inlet 124 is configured to receive a coolant flow from a cooling system (not shown) associated with the engine. The cooling block 106 may have a hollow structure defining an internal chamber 126 within the cooling block 106 in fluid communication with the inlet 124. The internal chamber 126 may include a number of continuous channels 128 providing a path for the coolant flow to circulate within the cooling block 106. A cross-sectional view of the cooling block 106 across cutting plane A-A′ is rendered in FIG. 3 to illustrate the internal chamber 126. Shape and dimensions of the channels 128 may vary based on the shape of the cooling block 106.

The outer wall 120 of the cooling block 106 that surrounds the recess 116 may include a portion of the internal chamber 126 therein, such that the coolant flowing through the internal chamber 126 may surround side surfaces of the actuator 108 present within the recess 116 of the cooling block 106. Also, the internal chamber 126 may form the channels 128 within a remaining depth of the cooling block 106. The term “remaining depth” used herein refers to a depth between the overall depth D2 of the cooling block 106 and the depth D1 of the recess 116. The internal chamber 126 is formed such that as the coolant actively flows through the internal chamber 126, a bed of the coolant may be formed within the cooling block 106. Heat exchange may take place between the coolant flowing through the internal chamber 126 and the actuator 108, thereby allowing the actuator 108 to cool.

An outlet 130 of the cooling block 106 is in fluid communication with the internal chamber 126. The outlet 130 is configured to discharge the coolant from the cooling block 106. The outlet 130 may be fluidly coupled to an inlet port 132 (See FIG. 1) of the valve body 102 through a pipe 134 (See FIG. 1). The coolant discharged from the cooling block 106 may enter into the valve body 102 via the inlet port 132. The coolant may circulate through the valve body 102 and exit through an outlet port 136 (See FIG. 1) of the valve body 102. The outlet port 136 of the valve body 102 may be coupled to the engine cooling system.

### INDUSTRIAL APPLICABILITY

The EGR valve 100 may be heated due to high temperature exhaust gas flowing therethrough. This heat from the exhaust gas may reach the actuator 108 through the shaft 110 via conduction and/or radiation from surrounding engine components, for example, exhaust manifolds. This may degrade performance and/or affect a life of the actuator 108. For example, when the actuator 108 is the electronic actuator, the actuator 108 may be sensitive to heat, causing electronics associated with the actuator 108 to malfunction if a temperature of the EGR valve 100 rises beyond a predetermined threshold temperature. The cooling block 106 provided herein may cool the actuator 108. The shape and dimensions of the cooling block 106 may vary based on the application.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An exhaust gas recirculation valve assembly for an engine, the exhaust gas recirculation valve assembly comprising:
an actuator having a shaft;
a cooling block comprising:
an inlet configured to receive a coolant flow;
a top face having a recess disposed therein, the recess configured to house at least a portion of the actuator therein;
a through hole in the top face configured to allow the shaft to pass therethrough; and
an internal chamber in fluid communication with the inlet, the internal chamber configured to provide a path for the coolant flow to circulate through the cooling block; and
an outlet configured to discharge the coolant flow; and
a valve body fluidly coupled to the cooling block, the valve body including at least one coolant passage disposed therein.
